(19) United States
(12) Patent Application Publication
(10) Pub. No.: US 2006/0103105 A1
(43) Pub. Date: May 18, 2006

(54) Standing cycle

(75) Inventor: Jeeng-Neng Fan, Taoyuan (TW)

Correspondence Address: TROXELL LAW OFFICE PLLC, SUITE 1404, 5205 LEESBURG PIKE, FALLS CHURCH, VA, 22041, US

(73) Assignee: Hsin Lung Accessories Co., Ltd.

(21) Appl. No.: 11/224,939

(22) Filed: Sep. 14, 2005

(30) Foreign Application Priority Data
Nov. 15, 2004 (TW) 093218217

(51) Int. Cl. B62M 1/00

(52) U.S. Cl. 280/221

(57) ABSTRACT

A standing cycle is comprised of two rear wheels and one front wheel; the wheel being connected to an erected handle to control turning; one or a plurality of pedal being disposed on either side behind the front wheel to drive a sprocket; and the sprocket further driving a transmission gear for the rider to advance for fun and exercise purpose.

### BACKGROUND OF THE INVENTION

(a) Field of the Invention

The present invention is related to a standing cycle, and more particularly to a cycle that the rider stands up to pedal for fun and exercise purposes.

(b) Description of the Prior Art

A rider of a cycle, e.g., a bike, a tricycle or even a unicycle usually has to alternatively step on two pedals each indicating disposed at an angle of 180° to keep the wheel(s) going to advance the frame. The rider has to always use both feet to step on both pedals to maintain them continuously cycling.

Furthermore, for the comforts of the rider, a seat is preferred to support the body of the rider so to permit both feet to exert full strength on pedaling. Accordingly, since the mobility of the trunk of the rider is compromised for being subject to the support by the seat, the rider enjoys less fun and even fails to promote the results of riding for exercise.

### SUMMARY OF THE INVENTION

The primary purpose of the present invention is to provide a standing cycle that provides fun and exercise results at the same time. To achieve the purpose, the present invention is comprised of a frame with a front wheel and two rear wheels; the front wheel is connected to an erected handle to control turning; one or a plurality of pedal is pivoted behind the front wheel at where on either side at where easy for the rider to step on; when stepped on up and down, and the pedal drives a sprocket, which in turn drives a transmission gear set attached to the rear wheels to advance the frame of the standing cycle.

### BRIEF DESCRIPTION OF THE DRAWINGS

FIG. 1 is a perspective view of a first preferred embodiment of the present invention.

FIG. 2 is a magnified view of a pedal construction of the first preferred embodiment of the present invention.

FIG. 3 is a schematic view showing operation of the pedal of the first preferred embodiment of the present invention.

FIG. 4 is a schematic view showing a sprocket construction of the first preferred embodiment of the present invention.

FIG. 5 is a schematic view showing that the pedal of the first preferred embodiment of the present invention.

FIG. 6 is a perspective view showing a second preferred embodiment of the present invention.

FIG. 7 is a sectional view showing the structure of a sprocket and a transmission gear set of the second preferred embodiment of the present invention.

### DETAILED DESCRIPTION OF THE PREFERRED EMBODIMENTS

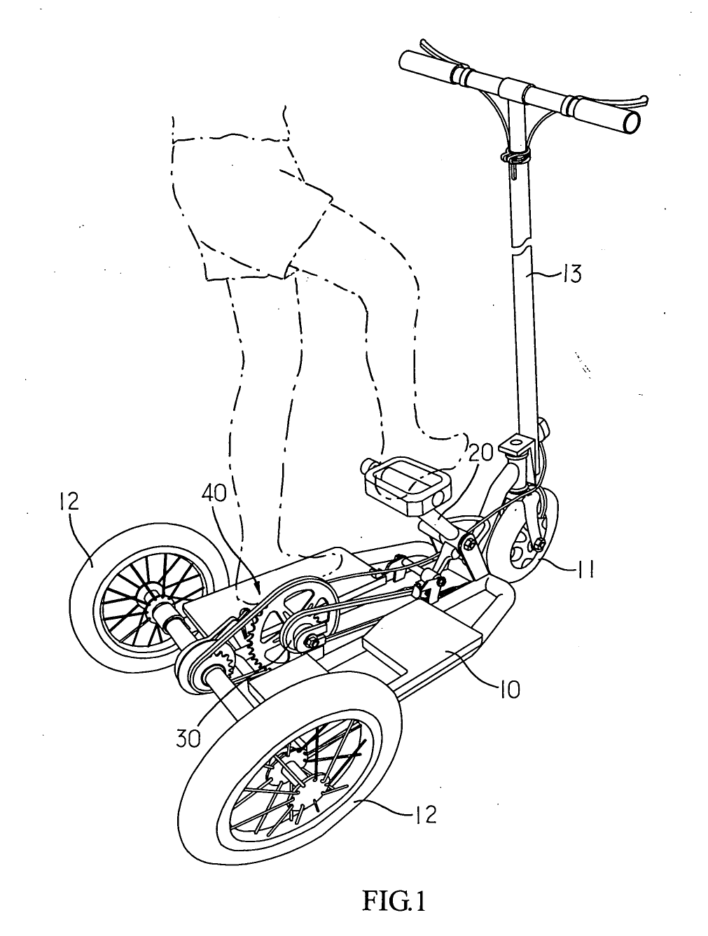

Referring to FIG. 1 for a first preferred embodiment of the present invention, a standing cycle is essentially comprised of two rear wheels 12 and one front wheel 11 disposed to a frame 10, and the front wheel 11 is connected to an erected handle 13 to control turning of the standing cycle. Wherein, one or a plurality of pedal 20 is pivoted to either side of the frame 10 behind the front wheel 11 at where easy a rider to step on. The pedal, when stepped on up and down by the rider, drives a sprocket 30, which in turn drives a transmission gear set 40 mounted to the rear wheels 12. Accordingly, the rider steps on the pedal with either foot to keep the frame 10 advancing to have fun and exercise results.

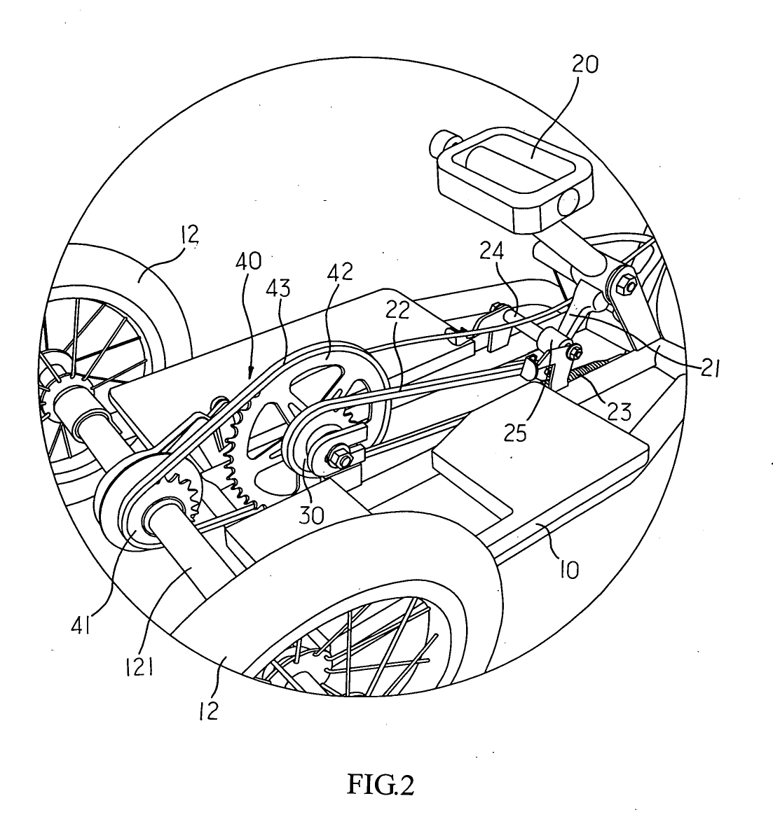

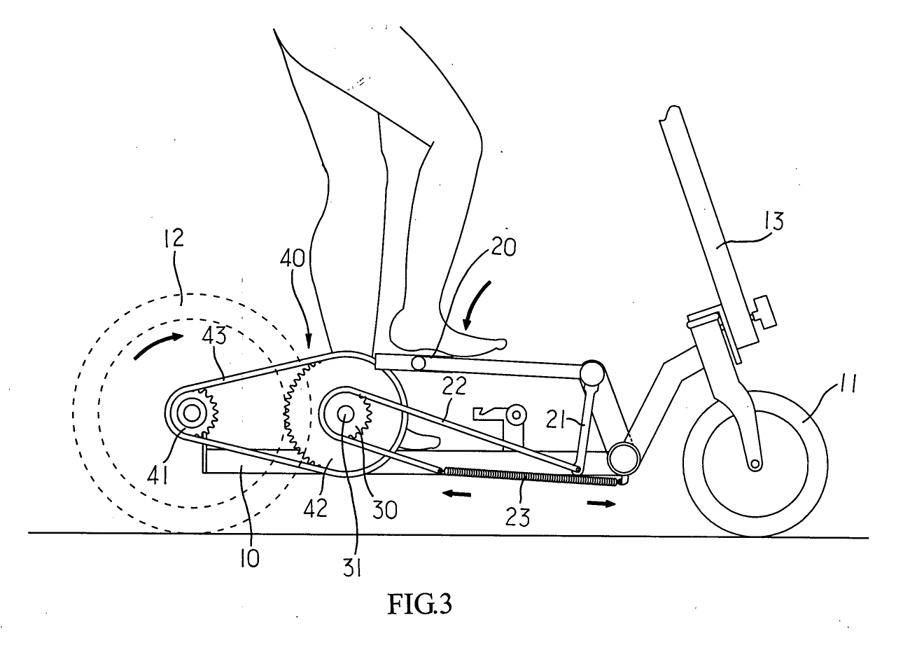

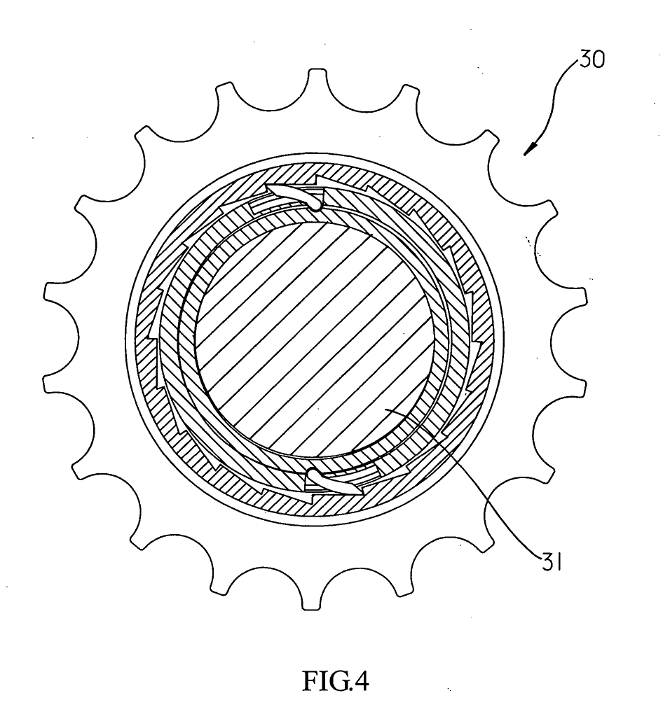

As illustrated in FIG. 2, a smaller gear 41 of a wheel axial 121 of the rear wheel 12 and a larger gear 42 directly driven by the sprocket 30 are disposed to the transmission gear set 40. The smaller gear 41 and the larger gears 42 drive both rear wheels 12 through the transmission by a chain 43 and the revolution speed of both rear wheels 12 may be accelerated by changing the gear ration between the smaller and the larger gears 41, 42. A lever 21 is pivoted to the pedal 20. The tail of the lever 21 is connected to a belt chain 22, which goes around the sprocket 30 and has another end of the lever 21 to connect to a return device 23 comprised of a tension coil. Accordingly, as illustrated in FIGS. 3 and 4, the lever 21 draws the belt chain 22 to drive a spindle 31 of the sprocket 30 to turn around, so to drive at the same time the larger gear 42 to advance. While the rider is not stepping on the pedal 20, the belt chain 22 for being subject to the force from the return device 23 is pulled in opposite direction to prevent the larger gear 42 from engaging reverse revolution when subject to the action by the sprocket 30.

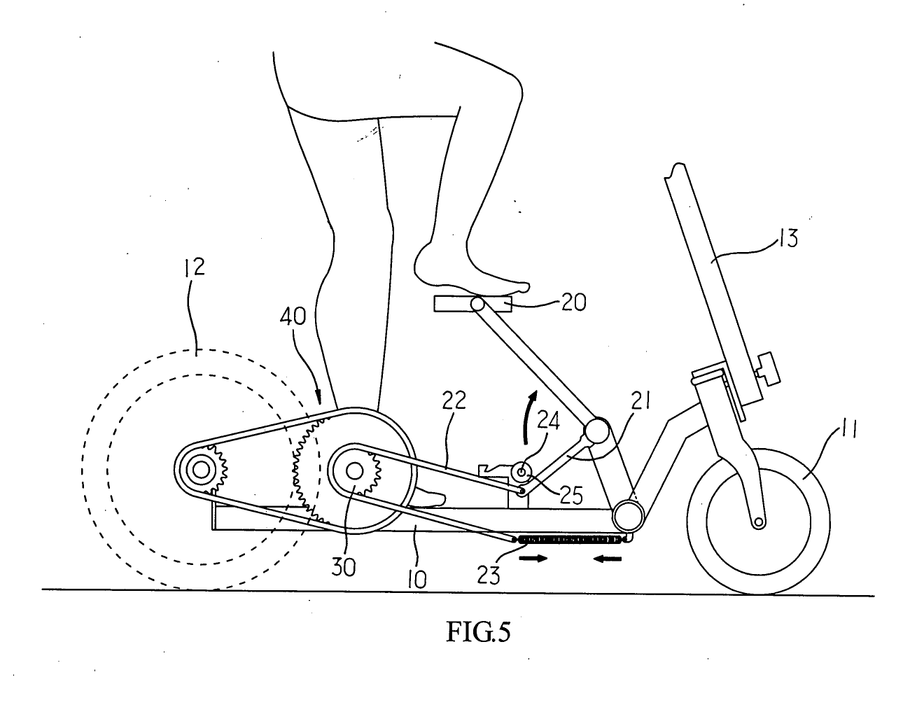

Now referring to FIG. 5, while the return device 23 draws the belt chain 22, the pedal 20 is also drawn by the belt chain 22 to rise up to its higher location for the rider to step on for keeping the frame 10 advancing. In the first preferred embodiment, a blocking lever 24 is disposed in the traveling route as the lever 21 of the pedal 20 swings. For being limited by the blocking lever 24, the pedal achieves the same height for its every elevation cycle. A rubber resilient member 25 is disposed to where the blocking lever 24 is provided to absorb the impact from the blocking lever 24 and to reduce noise level.

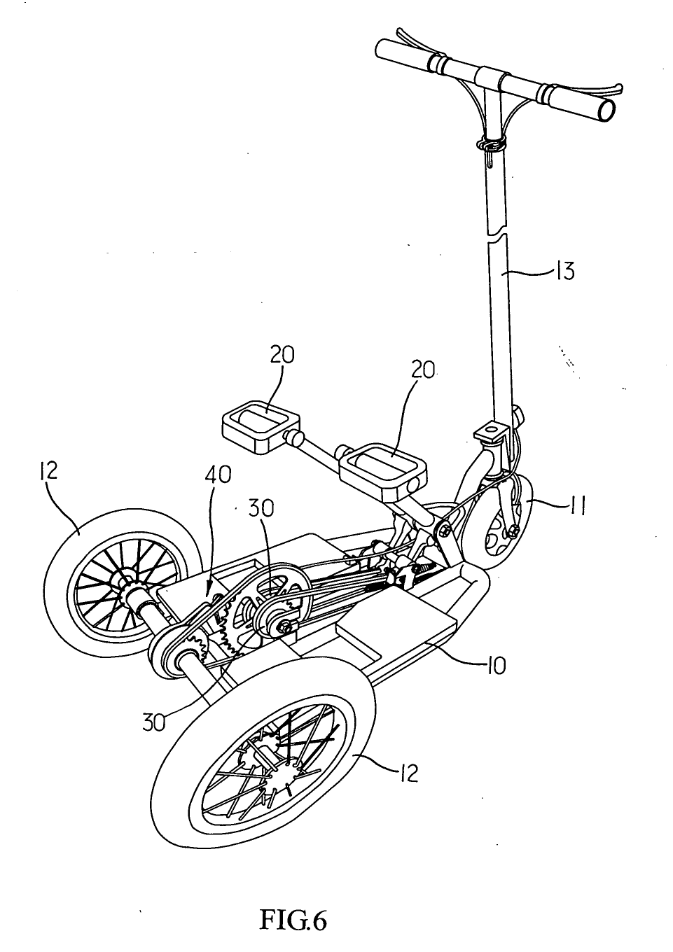

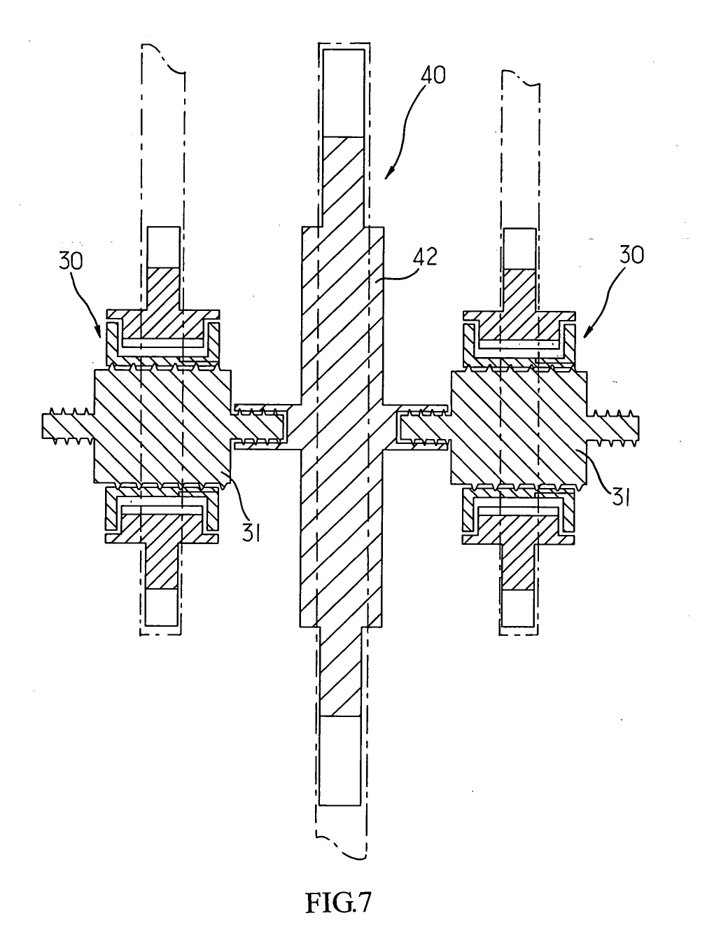

As illustrated in FIGS. 6 and 7 for a second preferred embodiment of the present invention, and two pedals 20 are provided and two sprockets 30 to individually drive the transmission gear set 40 mounted to both rear wheels 12. Both sprockets 30 are respectively connected to their respective pedals 20. Accordingly, the standing cycle of the present invention provides more options of having fun for the rider since the rider may have one foot to step on one pedal, or alternatively have both feet to step on one pedal, or have both feet respectively stepping on two pedals at the same time to make the standing cycle going ahead.

The prevent invention provides an improved structure of a standing cycle, and the application for a utility patent is duly filed accordingly. However, it is to be noted that that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A standing cycle is comprised of a frame, and one front wheel and two rear wheels being connected to the frame; the front wheel being connected to an erected handle to control turning; one pedal being pivoted on either side behind the front wheel at where easy for a rider to step on to drive a sprocket; and the sprocket driving a transmission gear set mounted to the rear wheels.

2. A standing cycle is comprised of a frame, and one front wheel and two rear wheels being connected to the frame; the front wheel being connected to an erected handle to control turning; two pedals being pivoted behind the front wheel at where easy for a rider to step on; two sprockets each independently drive their respective rear wheels being provided to the rear wheels, two transmission gears being respectively provided to both sprockets; and both pedals respectively driving both transmission gear sets.

3. The standing cycle of claim 1, wherein a lever is provided at where the pedal is pivoted to the frame; the tail of the lever is connected to a belt chain; the belt chain goes around the sprocket for the other end of the lever to connect to a return device; and the return device is related to a tension coil.

4. The standing cycle of claim 2, wherein a lever is provided at where the pedal is pivoted to the frame; the tail of the lever is connected to a belt chain; the belt chain goes around the sprocket for the other end of the lever to connect to a return device; and the return device is related to a tension coil.

5. The standing cycle of claim 1, wherein a smaller gear disposed to a wheel axial of the rear wheels and a larger gear being directly driven by the sprocket are disposed to the transmission gear set of the rear wheels; and a chain is provided for both of the larger and the smaller gears to drive the rear wheels.

6. The standing cycle of claim 2, wherein a smaller gear disposed to a wheel axial of the rear wheels and a larger gear being directly driven by the sprocket are disposed to the transmission gear set of the rear wheels; and a chain is provided for both of the larger and the smaller gears to drive the rear wheels.

7. The standing cycle of claim 1, wherein a lever is provided at where the pedal is pivoted to the frame; the tail of the lever is connected to a belt chain; the belt chain goes around the sprocket for the other end of the lever to connect to a return device; the return device is related to a tension coil; a blocking lever is disposed in the traveling route of the lever of the pedal as the lever swings; and the elevation height being restricted by the blocking lever.

8. The standing cycle of claim 2, wherein a lever is provided at where the pedal is pivoted to the frame; the tail of the lever is connected to a belt chain; the belt chain goes around the sprocket for the other end of the lever to connect to a return device; the return device is related to a tension coil; a blocking lever is disposed in the traveling route of the lever of the pedal as the lever swings; and the elevation height being restricted by the blocking lever.

9. The standing cycle of claim 1, wherein a lever is provided at where the pedal is pivoted to the frame; the tail of the lever is connected to a belt chain; the belt chain goes around the sprocket for the other end of the lever to connect to a return device; the return device is related to a tension coil; a blocking lever is disposed in the traveling route of the lever of the pedal as the lever swings; the elevation height being restricted by the blocking lever; and a resilient device is disposed at where the blocking lever is provided to absorb the impacts from the blocking lever and reduce the noise level.

10. The standing cycle of claim 2, wherein a lever is provided at where the pedal is pivoted to the frame; the tail of the lever is connected to a belt chain; the belt chain goes around the sprocket for the other end of the lever to connect to a return device; the return device is related to a tension coil; a blocking lever is disposed in the traveling route of the lever of the pedal as the lever swings; the elevation height being restricted by the blocking lever; and a resilient device is disposed at where the blocking lever is provided to absorb the impacts from the blocking lever and reduce the noise level.
